(19) United States
(12) Patent Application Publication
(10) Pub. No.: US 2015/0290987 A1
(43) Pub. Date: Oct. 15, 2015

(54) DEVICE FOR FASTENING AN ANTI-SKID CHAIN

(71) Applicant: CONFON AG, Rheineck (CH)

(72) Inventor: Werner Preusker, Sauldorf (DE)

(21) Appl. No.: 14/382,312

(22) PCT Filed: Jan. 17, 2013
(86) PCT No.: PCT/CH2013/000011

§ 371 Date: Dec. 5, 2014

(30) Foreign Application Priority Data
Mar. 6, 2012 (CH) 295/12

(51) Int. Cl. B60C 27/06; B60C 27/10

(52) U.S. Cl. CPC B60C 27/063; B60C 27/061; B60C 27/10

(57) ABSTRACT

The invention relates to a fastening device for an anti-skid chain (3), said device comprising a washer (23) having a clamping device (25) arranged thereon. The clamping device (25) is designed to draw a tension element (27) through a bore (31) lying at radial distance from the centre of the washer (23). The end of the tension element (27) is attached to a wheel bolt and draws the washer (23) towards the anti-skid device (3), wherein the tensile force of the tension element (27) runs axially with respect to the wheel bolt.

The subject of the invention is a device for fastening an anti-skid chain onto a wheel of a vehicle according to the preamble of patent claim 1.

In order to prevent the free wheeling or skidding of drive wheels of vehicles on ice and snow, and to increase friction when braking, anti-skid devices of various types are known. The most common type are chains, which are applied onto the tire tread and are held on the tire in different ways.

In order to simplify the mounting of chains or anti-skid device, it is known from EP 0 460 782 to hold the encircling, annular chain, which for the most part is made up of two chain strands with connection members spaced in between, on arms extending in star shape, and fastening the arms disposed in star shape on the rim or on one of the wheel bolts. Further, it is known to connect such anti-skid devices to a plate rigidly joined to the rim by suitable mechanisms, at least during the cold season. In the case of the latter design, it is very easy, even for inexperienced drivers, to attach the anti-skid device onto a wheel within less than one minute. With the introduction of aluminum rims, in particular so-called sport rims, it is often undesirable, for esthetic reasons, to have a plate permanently mounted over the rim. For this reason, devices of the above-named type that make possible a connection of the holding arms to only one of the wheel bolts have been introduced on the market.

It is known from practice that during driving, the chain lags the wheel, i.e., the rotational speed of the wheel is greater than that of the chain by several percent. This means that the chain, or the arms to which the chain is fastened, must not be joined rigidly with the rim. It is necessary that the connection between the arms or brackets that support the chain and the rim can be rotated around the axle of the wheel. This problem is solved in that the connection of the bracket to one of the wheel bolts is made complex, since in the devices of the prior art, a tension element, e.g., a cable or a belt is conducted from the center, i.e., the symmetrical center of the bracket, to one of the wheel bolts, in order to be able to hold the anti-skid device on the rim. For this purpose, a fixing element (adapter) with a thread connection is fastened onto one of the wheel nuts, this element remaining on the wheel during the cold season. A tube-shaped axial extension is screwed onto the thread connection, and a lever arm that is aligned radially to the center of the rim is fastened rotatably to the free end of this axial extension. The centrally acting tension organ is fastened to the free end of the lever arm, which must come to lie essentially in the axis of rotation of the wheel.

Due to the slippage of the chain on the tire, the brackets move past the wheel bolts, including the wheel bolt with the lever arm fastened thereto. In order to prevent a grinding at the edges of the expensive aluminum or magnesium rims, an extension that lifts the lever arm over the outer edge of the rim must be fastened to this arm. Because of this, a radial outwardly acting force always arises on a wheel when the anti-skid device is clamped on, and this force is reinforced by the relatively long length of the extension sleeve, i.e., the axially running lever. Alternating loads also arise on the wheel bolt due to the constant circulation of the anti-skid chain on the tire. Another disadvantage of this known device consists in the fact that the fastening of the sleeve or of the radially running lever fastened thereto is very cumbersome during every mounting of the chain, and the mounting is greatly hindered by the elements of the anti-skid chain, in particular the brackets.

An object of the present invention is now to create an anti-skid chain that can be joined to the wheel in a simple way and can be fully fastened to the latter. Another object is to design the anti-skid chain such that during the times when the anti-skid chain is not mounted, no axially projecting and thus dangerous elements on the wheel project far outwardly, and also the optical appearance of the wheel is not adversely affected.

This object is achieved by a device according to the features of patent claim 1. Advantageous embodiments of the invention are described in the dependent claims.

Due to the arrangement in which the tensile force of the tension element is produced on the at least one wheel bolt axially thereto, alternating loads acting radially on the wheel bolt can be avoided. In addition, it is possible to be able to mount the anti-skid chain in a very short time without the assistance of tools and without an expenditure of force. The driver of the automobile needs only to attach the suspension element to the adapter and then to clamp the tension element. This makes it possible to introduce the anti-skid chain onto the vehicle tire and to fasten it there securely in a few seconds, even under the most severe winter conditions.

The vehicle is thus only at a standstill for a very short time.

The advantages of the second embodiment are that the tension element of the clamping device can engage directly or approximately directly in the center of rotation of the wheel, since the engagement is not produced on an individual wheel bolt, but rather, in each case, on a bridge connecting two diametrically opposite-lying wheel bolts, this bridge being able to be plugged onto the two adapters without tools. This means that two wheel bolt adapters, which are supplied together with the chain, are fitted in turn either in advance of the cold season or generally only once, and thereafter the chain can be fastened to the wheel completely without tools. In their turn, the adapters do not project axially over the rim and thus do not interfere with the esthetics of the rim.

The invention will be explained in more detail based on an illustrated example of embodiment. Herein:

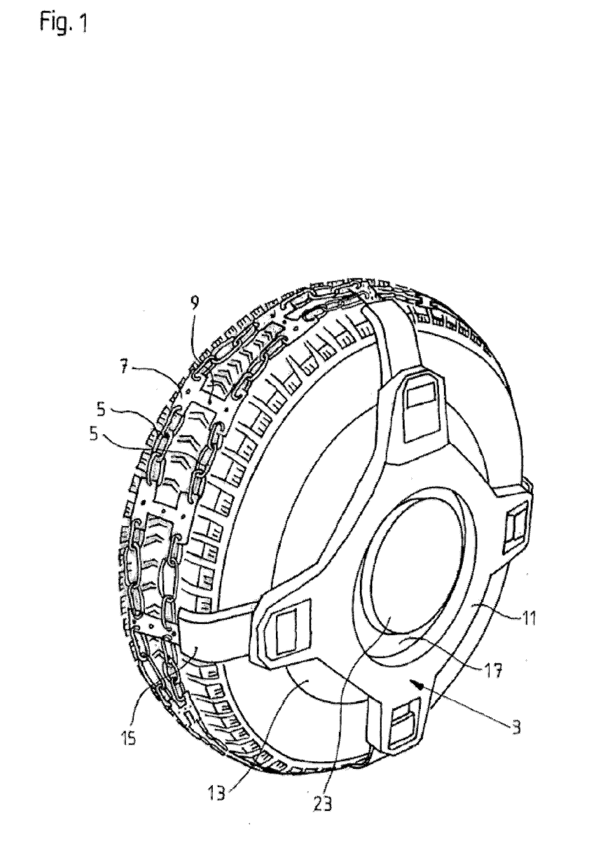

FIG. 1 shows a vehicle tire with an anti-skid chain fastened thereon;

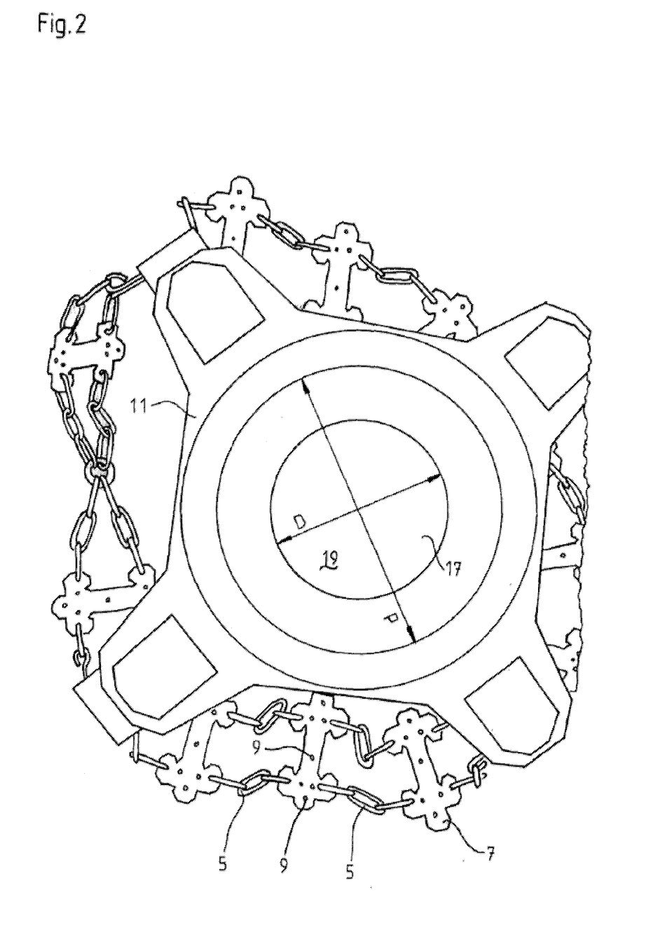

FIG. 2 shows the anti-skid chain with the holding brackets formed on a holding plate as well as the chain strands between the ends of the brackets;

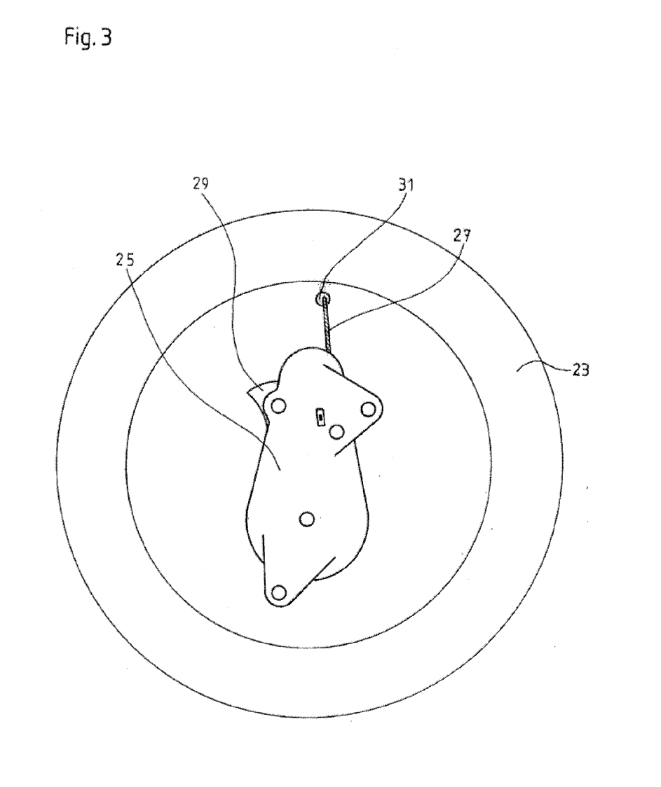

FIG. 3 shows a view onto a clamping device, mounted on a circular disk;

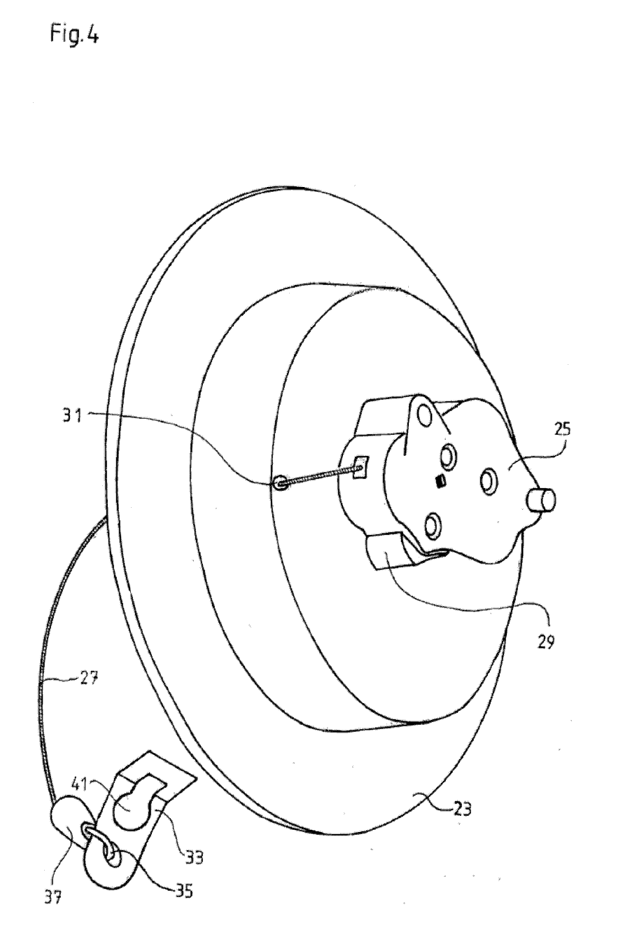

FIG. 4 shows a perspective representation of the disk with the clamping device and a tension element;

FIG. 5 shows the anti-skid chain with the holding brackets formed on a holding plate as well as the chain strands between the ends of the brackets with the clamping device mounted;

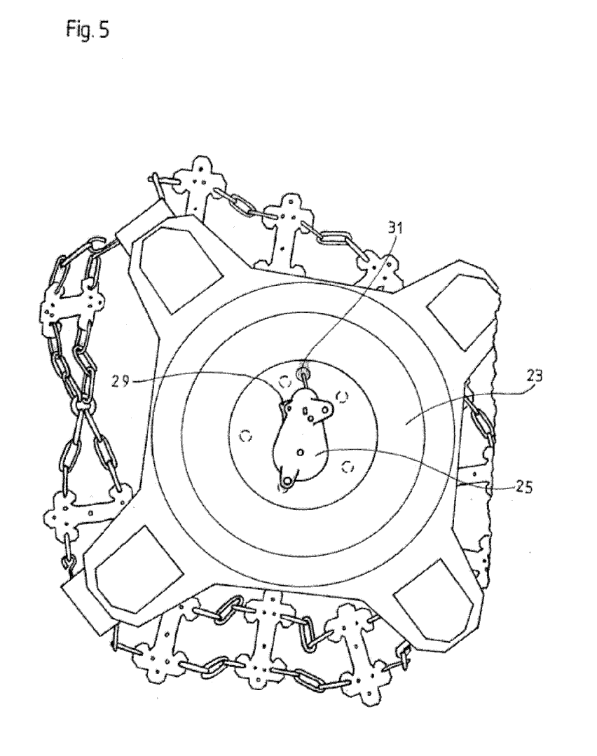

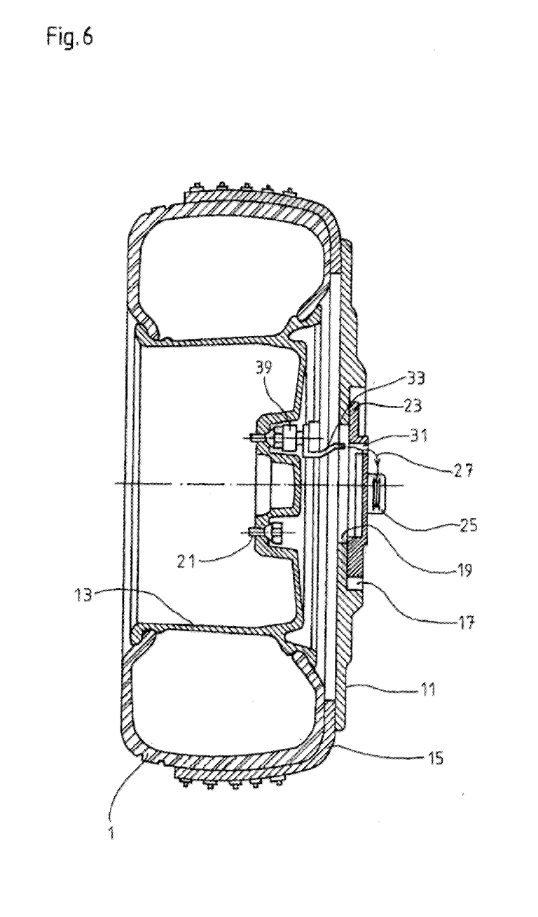

FIG. 6 shows an axial cross section through a tire having a device according to the invention for attaching the anti-skid chain;

FIG. 7 shows an axial cross section through the prior art according to EP 0 460 782;

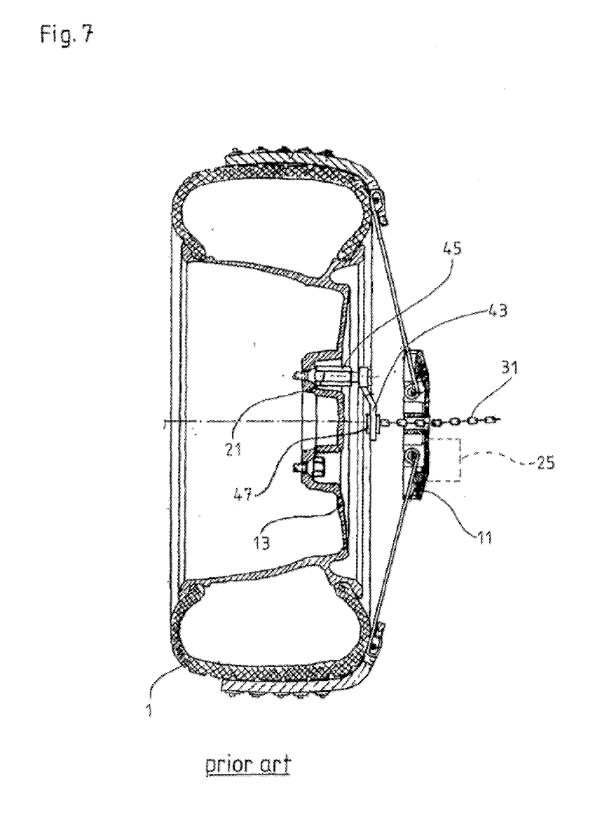

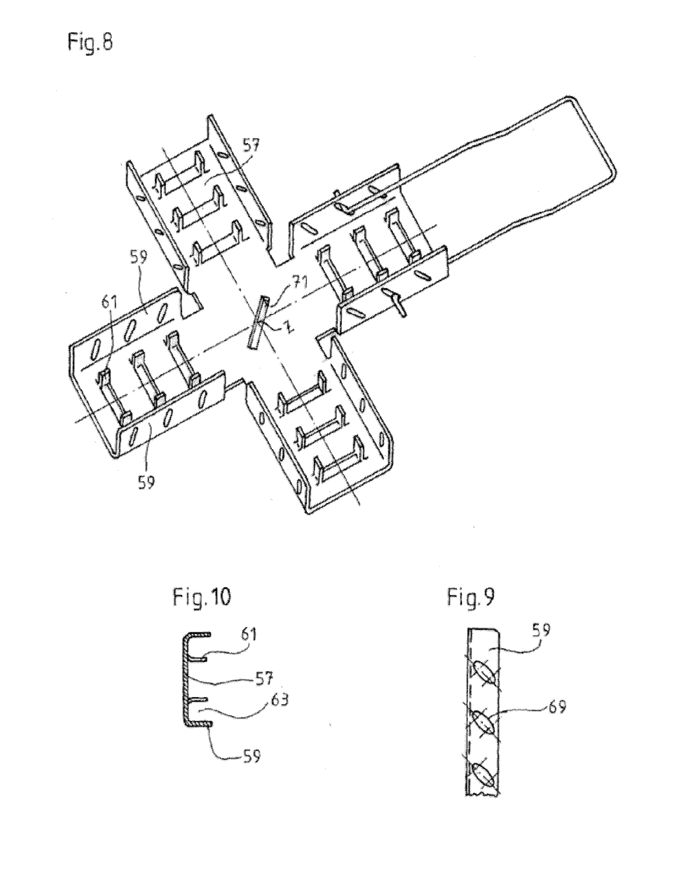

FIG. 8 shows a layout of a holding plate for wire holding brackets that can be plugged in, after stamping/prior to bending;

FIG. 9 shows a lateral view of an uptake wing for a wire holding bracket;

FIG. 10 shows a cross section through the wing according to FIG. 9;

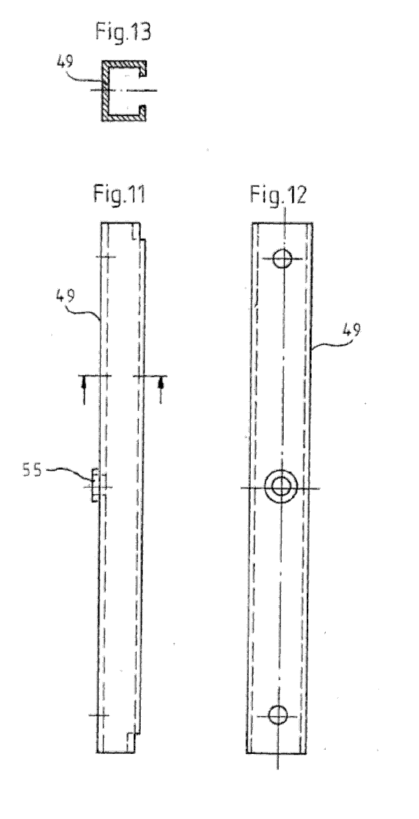

FIG. 11 shows a lateral view of a connection element;

FIG. 12 shows a view onto the connection element;

FIG. 13 shows a cross section through the connection element along line XIII-XIII in FIG. 11;

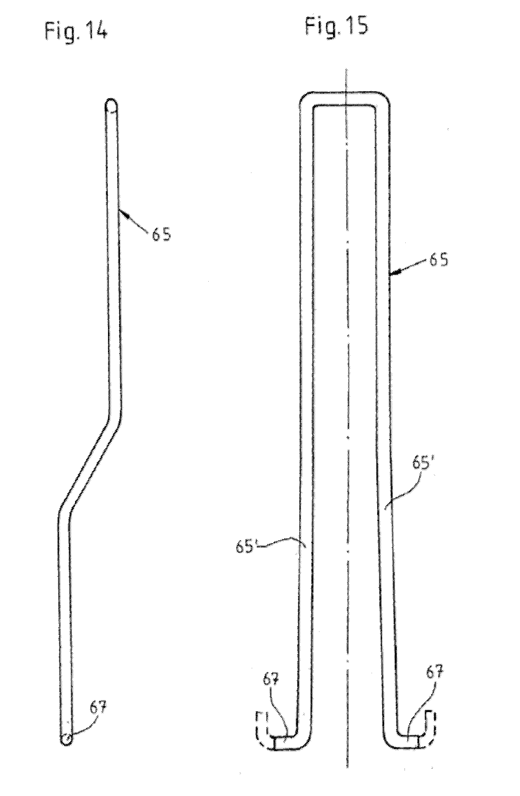

FIG. 14 shows a lateral view of the holding bracket;

FIG. 15 shows a view onto the holding bracket;

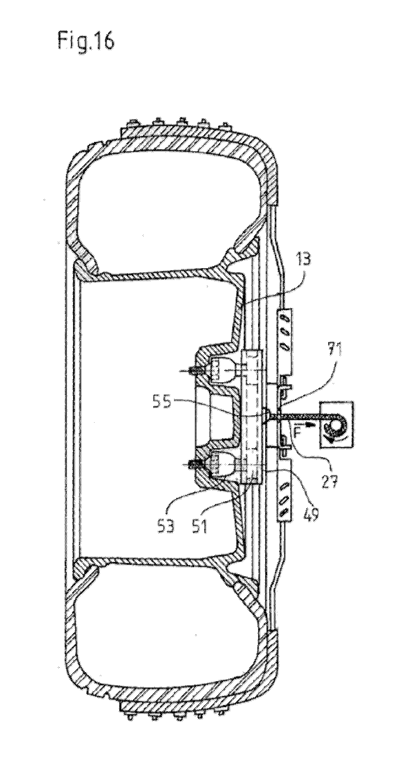

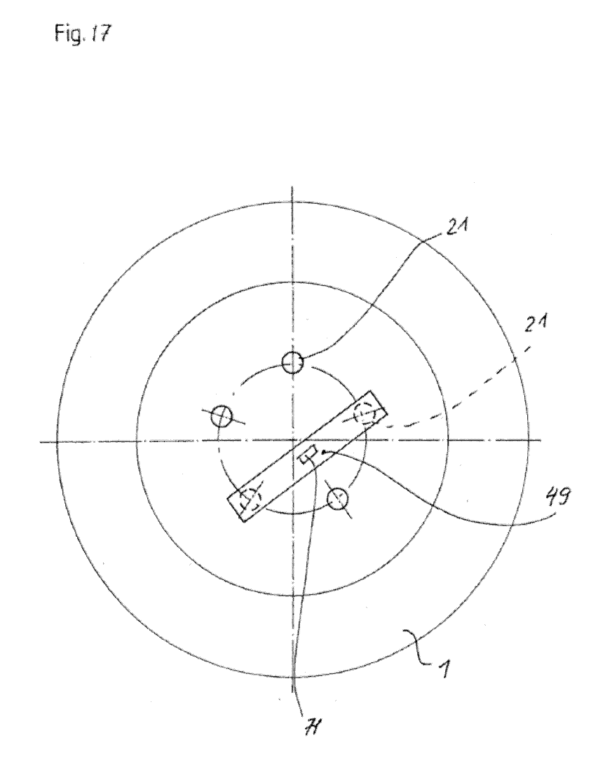

FIG. 16 shows an axial segment through a wheel with the device mounted on its rim; and

FIG. 17 shows a schematic view onto a tire with a fastening element fastened onto two wheel bolts.

An anti-skid chain 3 is shown on a vehicle tire, or tire 1, in a perspective illustration in FIG. 1. The expression anti-skid chain 3 in the present invention comprises two chain strands 5, which lie on the tire tread, running partially parallel, partially V-shaped, in the example shown. The two chain strands 5 are kept at a distance by crosspieces 7, on which spikes 9 are arranged. For example, four holding brackets 15 are pivotably fastened to a holding plate 11, which is disposed on the front side relative to tire 1 and lies over a rim 13.

The holding brackets 15 extend over the edge of the tire 1 into the tread of tire 1 and support as well as position the two chain strands 5. In the center of the holding plate 11, a circular recess 17 is formed, in the center of which lies a circular opening 19. The diameter D of the circular opening is larger than the diameter of the bolt circle for the wheel bolts 21 on the rim 13. The above-described elements of the anti-skid chain 3 are known from the prior art. Such anti-skid chains are produced by the company Confon AG, CH-9424 Rheineck.

In order to be able to fasten the anti-skid chain 3 onto a tire 1 or a vehicle tire, a clamping device 25 is fastened onto a circular disk 23, the diameter of which is smaller than the diameter D of the recess 17. The clamping device 25 comprises a cable drum, which is not visible in the figures, as well as a spring joined to the cable drum, which takes up a tension element 27 that retracts into the housing of the clamping device by means of the spring, if a pulling-out force acting on the tension element 27 decreases. The clamping device 25 further comprises a press piece 29, with which, on the one hand, can block the drum against a further pulling out of the tension element 27, and, on the other hand, can block the pulling in of the tension element due to the force of the spring, or the block can be removed. Clamping devices 25 of the type shown are commercially available. Their structure may also be different, e.g., a drum driven by a hand crank for clamping the tension element 27, or, in the case when the tension element 27 is formed as a belt, the winding drum can also be actuated by a ratchet known from DE 8 132 887 U1.

The tension element 27 passes through the disk 23 in a guide bore 31 at a radial distance e relative to the center of the disk 23. The radial distance of the bore 31 from the center of the disk 23 essentially corresponds to the radius of the bolt circle for the wheel bolts 21 in the rim 13 of the wheel.

At the end of the tension element 27, a suspension device 33 is fastened in a flexible manner. Preferably, the suspension device 33 hangs in a loop 35 of the tension element 27 or in a ring permitting a flexible connection between tension element 27 and suspension device 33. Of advantage also, a stopper element is inserted between tension element 27 and suspension device 33, the stopper element, on the one hand, abutting the underside of the disk 23, when the tension element 27 is drawn in from the clamping device 25, and, on the other hand, facilitating the manipulation of the suspension device 33, when the latter is pulled out from the clamping device 25 during the fastening of the anti-skid chain 3 to a wheel bolt 21 or to a fixing element 39 fastened to the wheel bolt 21. The fixing element 39, which is fastened in the known way to the head of a wheel bolt 21, comprises, for example, a bell-shaped unit, in which clamping elements acting radially inwardly can be activated by means of a tension bolt, so that the bell-shaped unit is fastened at the head of the bolt 21 so that it cannot be detached. For example, a bolt with a mushroom-shaped end, in which the suspension device 33 can be suspended, is formed via the bell-shaped unit, and after this is held so that it cannot be detached by the tension of the tension element 27. In order to prevent suspension device 33 from falling out due to vibrations and the like, for example, a keyhole-shaped punch 41 is introduced in the latter, and the head of the wheel bolt 21 can be guided through this keyhole.

The fastening of the anti-skid chain 3 onto a tire 1 mounted on the vehicle and resting on the ground is described in more detail in the following.

The anti-skid chain 3 is shifted onto the tire 1 essentially axially from outside, i.e., all four holding brackets 15 shown in the example engage the edge of the tire 1 and move the chain strands 5 outward onto the tire tread in the contact region with the street. The two chain strands 5 that extend between the two holding brackets 15 and that lie on the ground in front of and behind the contact area of tire 1 remain in the region of the tire edge. The disk 23 is now held by hand at the clamping device 25 and the suspension device 33 at the end of the tension element 27 is attached to the fixing device 39, which is fastened to one of the bolt screws 21 in the winter season. By pressing the press piece 29, the blocking in the clamping device 25 is released, and the tension element 27 is drawn into the latter, i.e., wound up on a drum. Or, the tension element 17 will be clamped in another way. Due to the force of the tension element 27 or the tension spring inserted in the clamping device 25, the disk 23 is drawn into the recess 17 at the holding plate 11 and in this way pulls the holding plate 11 with the brackets 15 axially at the tire 1. By a corresponding actuation of the press piece 29 or by a ratchet arrangement, the tension element 27 can be held in the drawn-in or retracted position.

After several meters of travel, both chain strands 5, which initially still rested on the tire edge, now lie over the tire tread.

The force of the tension element 27 acts axially relative to the wheel bolt 21 and no disruptive alternating loads arise due to the lag of the anti-skid chain 3 on the tire 1 in the radial direction onto the wheel bolt 21 and the fixing element 39 placed thereon.

In order to remove the anti-skid chain 3 from the wheel, only the clamping of the clamping device 25 needs to be released, and the suspension device 33 on fixing element 39 will be detached.

A cross section through the device of the prior art is shown in FIG. 7 for comparison of the initially named prior art according to European Patent 0 460 782. The different course of the tension element 31 can be seen therein, a course that does not engage the wheel bolt 21 axially and directly, but rather engages a pivot bearing 47 at the end of a lever 43, which bridges the radial distance between the axis of the wheel bolt 21 and the axis of rotation of the wheel. In addition to an axial extension piece 45, there must be formed at the end of the latter piece, i.e., between the lever 43 and the extension piece 45, another rotational or pivot connection. In addition, it can be seen that the tension element 31 cannot be directly connected to the wheel bolt 21 during the mounting of the anti-skid device, but rather that the lever 43 must be fastened rotatably on the tension element 31, and then the free end of the lever 43, in an awkward way—and only possible with great effort in cold winter temperatures and falling snow—must be fastened to the wheel bolt or to the extension piece 45 on the same. The extension piece 45 must also have a long axial length, so that the lever 43 does not come in contact with parts of the rim when the anti-skid element rotates on the tire during driving, and the lever 43, in its turn, is rotated around the axis of the wheel bolt 21.

In one embodiment of the invention, of course, without the advantages of a coaxial action of the clamping device 25 on the wheel bolt 21, the device could be placed on the holding plate 11 of an anti-skid device designed according to the prior art. This type of placement of the clamping device 25 is shown by the dashes in the illustration of the prior art according to FIG. 7.

In another embodiment of the invention, the clamping device can also be joined to the central bolt or nut with which the wheel mount is fastened to the wheel suspension, so that an axially running tension is assured.

Alternatively to the clamping device 25 having a spring, a ratchet, a winch, or another device exercising tension on the tension element 27 could also be provided.

In another embodiment of the invention, the free end of the tension element 27 engages a connection element 49, which joins together as a bridge the two head parts 51 of two adapters 39 lying opposite one another (FIG. 16). The end of the tension element 27 is fastened to a rotatable tab 55 or to another suitable element producing a rotatable connection.

The individual elements of the device will be defined in more detail in the following. The holding plate 11 for the holding brackets 55 is shown in FIG. 8 partially as being processed and partially already bent. This is configured as an X shape with the use of four holding brackets 55, and correspondingly configured as a star shape with five holding brackets; i.e., four, five, or six arms 57 run out from the center Z (FIG. 8). The edges 59 of the arms 57 are bent by 90° so that a “U” is formed (see FIG. 10). Two or more tabs 61 can be formed between the edges 59, these tabs also being bent, so that intermediate spaces 63 that guide wire holding brackets 65 laterally are formed between the edges 59 and the high bent tabs 61. As they are shown in FIGS. 14 and 15, the wire holding brackets 65 have a U-shaped configuration and their ends 67 are bent outward at a right angle or U-shaped outwards and to the back. The ends 67, when attached onto the holding plate 11, pass through the edges 59 in bores 69 formed therein (see FIGS. 9 and 16) or in diagonally placed slots. The wire holding brackets 65 can be inserted between the edges 59 without tools by pressing their arms 65′ together, and then, fitted to the diameter of the rim 13, are suspended in the suitable bores or slots 69 lying opposite one another.

The wire brackets 65 remain held therein thanks to the tension built up by pressing the arms together, even when they are bent up relative to the Z axis when not used, in order to confine the device to a small space.

As shown in FIG. 14, the wire brackets have a bent shape or they may be formed as straight.

An opening 71 is formed in the center of the holding plate 11, through which the tension element 27 can be guided from the clamping device 25 to the tab 55 introduced rotatably onto the connection element 49.

Only the connection element 49 serves as the connection means of the tension element 27 to the rim. The connection element can be moved without tools onto two adapters 39 lying essentially diagonally opposite one another (in 5-hole rims) (see FIG. 17). In the case of 6-hole rims, onto two diagonally lying adapters 39. Catches that are suitably formed (not shown) hold the connection elements 49 securely on the adapters 39 during driving, once they have been put in place. Elements, e.g., spring tabs or lugs, which prevent a displacement of the connection element 49 on the two adapters 39, serve as the catches.

Instead of the holding plate 15 or wire brackets 65 described in FIGS. 8 to 10 as well as 14 and 15, a holding plate 11, as it has been described in the first example of embodiment (FIGS. 1 to 7), may also be utilized. Likewise, a holding plate, as is known from the prior art, for example in EP 0 460 782, or one such as is known as the CENTRAX Model of the Rud company, the Trak Sport of the Maggi Catenesta company, or the K-Summit of the Toole company, may also be utilized.

All of the above-described holding plates 11 can be joined to the rim 13 by the connection element 49 according to the invention, without the necessity of an element for this purpose held rotatably on a wheel bolt 21 that compensates for the slippage of the chain 3 on the wheel. The connection element 49 or the fastening tab 55 or another element that makes possible a rotation relative to the connection element 49 lies exactly over the axis of rotation of the wheel in the case of rims with six holes for the wheel bolts, and is slightly offset in the case of the frequently encountered five bores. This slight eccentricity of the tab 55, however, is negligible.

1. A device for fastening an anti-skid device onto a vehicle wheel, comprising an anti-skid chain, which is held in position by a plurality of holding brackets fastened to a holding plate in star formation; a tension element, which is joined to a clamping device specified for winding up or for clamping; a suspension device introduced on the free end of the tension element for joining the free end of the tension element to an adapter 39 onto a wheel bolt,
is hereby characterized in that
the tension element can be joined to an adapter on a wheel bolt in such a way that the direction of tensile force of the tension element lies essentially in the axis of the wheel bolt.

2. The device according to claim 1, further characterized in that for the bracket, the holding plate has a central circular opening that is disposed in a circular recess of the holding plate, and in that the clamping device is placed on a disk * that can be inserted in the recess and the tension element passes through the disk in a bore, which bore lies radially outside the center of symmetry Z of the disk, wherein the radial distance R of the bore from the wheel center Z corresponds to the radius of the hole circle in the wheel rim, in such a way that the tensile force of the tension element engages or acts axially on the wheel bolt.

3. The device according to claim 2, further characterized in that the suspension device is formed so that it can be attached without tools to an adapter joined to the wheel bolt.

4. The device according to claim 3, further characterized in that the adapter has an axial length I that is similar to the head of the wheel bolt and, placed on the wheel bolt, does not pass through a plane E that is formed by the outer edge of the wheel rim.

5. The device according to claim 3, further characterized in that the suspension device has a keyhole-like opening, which permits the connection of the tension element to the adapter on the wheel bolt without tools.

6. The device according to claim 2, further characterized in that the disk with the clamping device can be rotated in the opening on the holding plate.

7. The device according to claim 2, further characterized in that a ratchet, a winch, or another device exercising tension on the tension element is utilized as clamping device.

8. The device according to claim 1, further characterized in that the free end of the tension element is rotatably connected to a rod-shaped connection element, which connection element is specified to engage on two wheel bolts lying diagonally opposite, approximately or exactly.

9. The device according to claim 8, further characterized in that the connection element is formed so that it can be suspended or moved onto two adapters fastened onto two wheel bolts.

10. The device according to claim 9, further characterized in that the connection element has on its ends a c-shaped cross section, and the two edges of the c-shaped connection element are specified to engage in circumferential grooves on the adapters.

11. The device according to claim 10, further characterized in that catch means are formed on the connection element for locking the connection element on the adapters.
